(19) United States
(12) Patent Application Publication
(10) Pub. No.: US 2013/0035954 A1
(43) Pub. Date: Feb. 7, 2013

(54) Genomics-based alerting systems

(71) Applicants: James Plante, La Jolla, CA (US); David Becker, San Diego, CA (US)

(72) Inventors: James Plante, La Jolla, CA (US); David Becker, San Diego, CA (US)

(73) Assignee: Pathway Genomics

(21) Appl. No.: 12/387,782

(22) Filed: May 7, 2009

(51) Int. Cl. G06Q 50/24

(52) U.S. Cl. 705/3

(57) ABSTRACT

A computer alert to system and apparatus is arranged about DNA sequence markers whereby the genome of a specific human subject is considered in view of a plurality of discrete rules to affect alerts which may be generated and transmitted in electronic form over standardized e-mail systems (Internet/SMTP protocol for example) to a user workstation which may be equipped with a browser or custom application (includes a special genome viewers, review tools; etc.). Alerting systems described in this disclosure included mechanical/a chemical systems for analyzing a human DNA sample to produce a genomic data set representing genetic indicators or markers on alleles of interest including those as well SNPs associated with important trial traits disease and characteristics. A genome dataset is stored as a portion of a data a record having a one-to-one correspondence with membership in a membership database. A dynamic rules that of its reality of discrete rules provides a query engine with logic which can be executed against membership data stored in accordance with standardized database procedures to produce a genomic result set from which appropriate alerts may be formed in an alert to module computer apparatus. These alerts may be characterized as including multimedia information and they may be prefer to play conveyed to membership with whom the underlying data is associated.

### BACKGROUND OF THE INVENTIONS

### Field

The following invention disclosure is generally concerned with automated systems for parsing and distributing genetics information and more specifically concerned with information parsing and distribution based upon ones personal genome. The genetics research community produces remarkable new results related to human health and disease on a frequent and continuous basis. A great plurality of researchers and research institutions are dedicated to regularly produce new results related to and based upon the human genetic composition. Even experts in the field find it difficult to keep abreast of the fast-moving and highly dynamic scientific body of knowledge which describes the human genome and implicit health-related issues. With regard to personal health, the layperson relies upon the expertise of her personal physician but can do little more to realize benefit from new genetic discoveries—other than wait for several years until an important genetic discovery matures and propagates through the health system until it reaches the neighborhood doctor's office. However in recent months commercial providers of genetic testing services have arisen to provide the general public with an exceptionally high degree of access to their genome for a relatively low-cost. Although a person may now gain a remarkably detailed look at their own genetic makeup, they still are faced with the daunting task of interpreting its meaning and implications with respect to personal health and disease. While consultation with personal physicians and even review of the latest studies might aid one in understanding implications of one's genetic makeup, it remains an extremely cumbersome exercise to digest genetic studies and reduced them to discrete rules upon which health decisions can be base. It is therefore highly desirable to deploy automated systems which reduce massive amounts of newly published research information into discrete definitions and rules and still further to automatically sort information based upon any particular genome and distribute information to persons in accordance with the particular genetic features of their specific genome. In this way, one can avoid parsing new genetics research to find those studies which apply to their ones own genetic composition.

### SUMMARY OF THE INVENTION

Comes now, James Plante and David Becker with inventions of a genomics-based alerting systems including devices and methods responsive to a membership's genomic data for providing electronic alerts in view of newly developed research. It is a primary function of these member systems or genetic based ‘direct to consumer’ systems to provide highly relevant information in the form of an ‘alert’ in view of a member's particular genetic profile.

Systems for genetic information parsing and distribution have been devised and invented and are now herein first disclosed. These genome-based computer alerting systems are primarily formed of a membership database which allocates storage capacity for both genomic data and electronic communications addressing information and forms an association therebetween for each of included members. These alerting systems further include rules embodied as stored computer logic which depends upon parameters related to genetic features (i.e. genes, SNPs, copy #, et cetera). From time-to-time, a query engine portion of an analyzer module executes queries against data stored in the membership database, those queries having been formed in view of these prescribed rules. A result set returned includes those members who may be affected or otherwise interested by way of particular features of their personal genome. In response to inclusion of any members in a result set produced by an executed query, a system alert module automatically generates a report describing how the new research might be of interest and distributes that report accordingly with an electronic communications systems such as an e-mail server.

The invention thus stands in contrast to methods and devices known previously. The invention includes automated alerting systems which provides alerts to members particular to their genetic profile in view of newly released research data.

### OBJECTIVES OF THESE INVENTIONS

It is a primary object of these inventions to provide genetic membership systems for providing electronic alerts.

It is an object of these inventions to provide direct to consumer genetics analysis and monitoring.

A better understanding can be had with reference to detailed description of preferred embodiments and with reference to appended drawings. Embodiments presented are particular ways to realize these inventions and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a general block diagram of an example version of alerting system in accordance with the invention; and

FIG. 2 is detailed block diagram of another important version of an alerting system in agreement with these teachings.

### PREFERRED EMBODIMENTS OF THE INVENTION

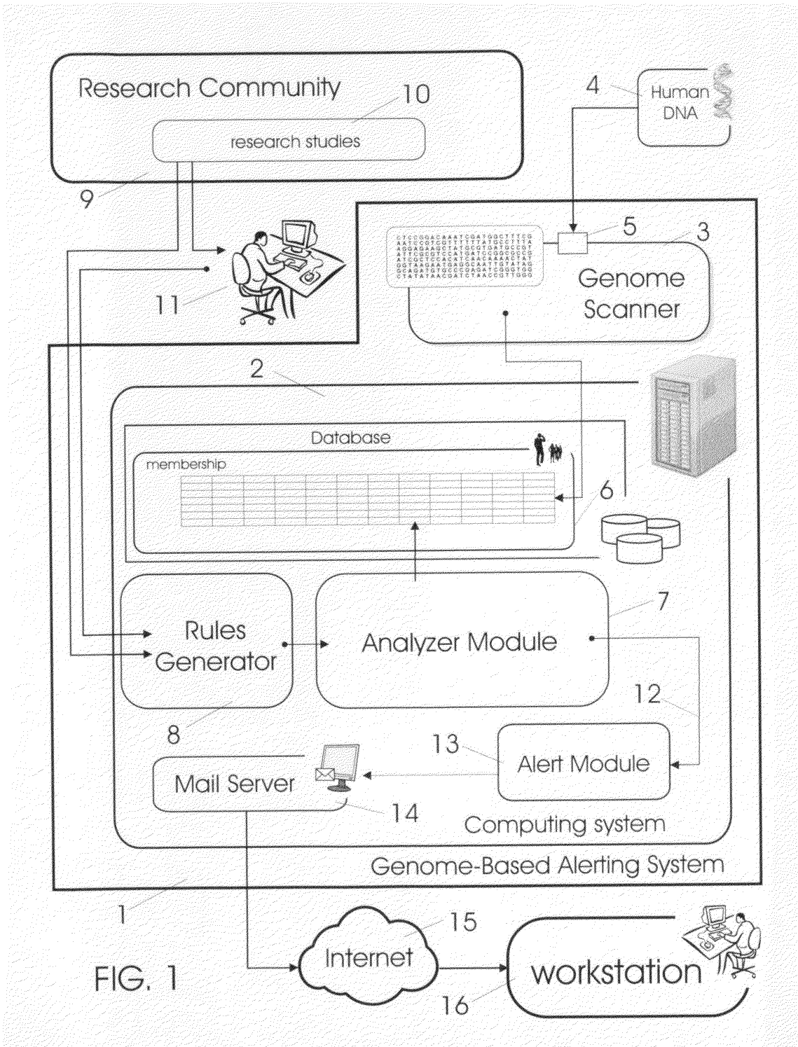

In a first important illustrative example, a genome-based computer alerting system of the invention is presented in conjunction with the diagram of FIG. 1. In particular, a genome-based alerting system 1 is comprised of a computer server 2 or computing system coupled to a genome scanner 3. A human DNA 4 sample is received as input at a receiving port 5 of the scanner. The genome scanner uses modern biological, chemical, optical and electronic processes to isolate particular genetic sequences including important SNPs (single nucleotide polymorphisms) as well as other sequences of interest. The genome scanner converts a human genome to a digital output which may be stored in a specially prepared membership database 6.

Member records which may include digitized genome type data, among others, are stored for each of a plurality of members. The database schema are configured such that there is a one-to-one correspondence between members and associated genomes stored. These may be coupled via a unique identifier database index mechanism or ‘primary key’.

An analyzer module is arranged to interrogate the membership database in accordance with database queries generated therein. Those database queries are formed in view of dynamic and updated rules continuously produced and supplied to the analyzer module by a rules generator 8. The rules generator produces rules represented as computer logic in response to inputs received from the research community 9 and in particular research studies 10 which include conclusions that way depend upon presence or absence of particular genetic features.

In some most preferred versions, an expert 11 is available to review research studies and to convert nondiscrete conclusions into discrete rules and algorithms. This expert may work in cooperation with a user interface provided as part of the rules generator whereby the research may be converted into an entirely logical representations thereof.

Alternatively, certain research may be coupled to the rules generator via fully automated systems which are arranged to parse and interpret data. This is particularly so where a researcher presents research results in a prescribed format which may be parsed by automated systems. In response to an analyzer module having executed a query or queries against the database, a result set 12 is conveyed from the analyzer module to the alert module 13. An alert module is comprised of all facility necessary for preparing reports in accordance with information received as a result set. An example, where a result set identifies a particular marker with a genetic characteristic identified in a new study, a report is prepared with detailed to explain the circumstance to an affected member. The report may be directly addressed to the member. Certain report may be configured for consumption by a member's agent or representative, for example a physician. Accordingly, the alert is sent to a designated address and the report format may be compatible with the particular expertise of the recipient.

An electronic distribution system may be configured for example as an e-mail server 14 which receives prepared reports from the alert module and directs them automatically in agreement with the appropriate members e-mail address, the e-mail address having been previously associated with the member's genome via the database schema, via the Internet 15 to a member's workstation 16 where it may be received and reviewed by the user. In this way, a person is provided a continuous coupling to newest research via their personal genome. It is no longer necessary to comb through millions of documents looking for those which might relate to the individuals particular genetic makeup, but rather, “cutting edge” new research comes to the user/member automatically.

A very short time after a new genetic discovery is published publicly, system users having a genetic signature which relates to the study are made aware of the new results without taking any action whenever. The system response may be characterized as an “information push” action where reports and information are delivered automatically with a request stimulus from the user.

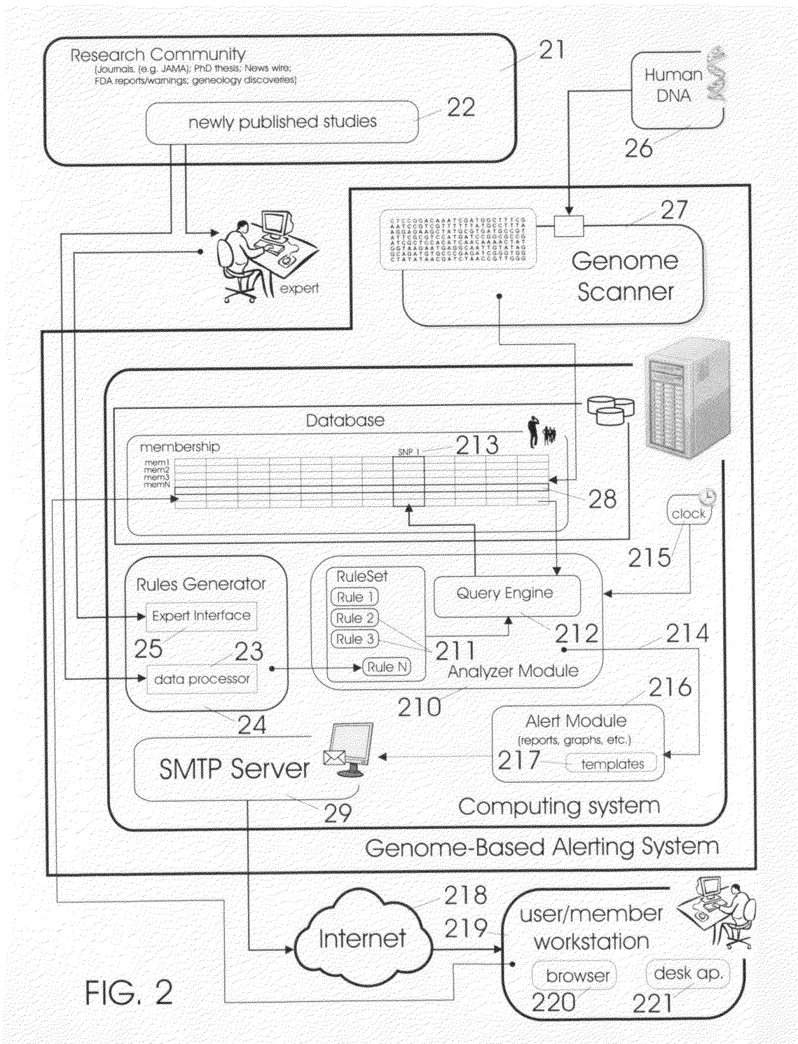

One gains a more considerable understanding in view of the detailed illustration of FIG. 2. A research community 21 regularly produces publications which document new genetics related medical research results. These may include but are not limited to publications such as medical journals, periodicals, Ph.D. thesis, newswire, FDA reports/warnings, geology studies, et cetera. Newly published studies 22 may be provided in a format which cooperates with machine processing whereby the results suggested therein are parsed and interpreted by a data processor 23 component of a rules generator 24 to arrive at discrete computer executable logic in the form of a rule or algorithm having dependence upon for example a particular genetic marker.

Alternatively newly published studies may be received by a human expert to interpret results and form logic and rules which are discrete and machine executable. In this instance, an expert interface 25 component of the rules generator is provided such that an expert is able to manipulate the states and variables of prescribed template rules to arrive at algorithms and logic which reflect the nature of the studies being read. This discretization step permits a study which is not easily parsed by automated systems to be converted to a discrete rule or rules that with the aid of a human interpreter.

The system is initiated with respect to a member individual when a DNA sample 26 is deposited at a receiving port of the genome scanner system 27. The output of the genome scanner is a digitized representation of a person's genome and this digitized representation is coupled to a member database with respect to a certain individual, the genome data is stored in the member database having specially prepared schema where a one-to-one relationship correspondence between members and any particular genome are enforced. In some preferred embodiments, this information is stored in a single database record (represented as a data row 28 in the illustration). Each member may be allocated a different database record in this manner for example.

In addition to genomic information, a database record may additionally provide for storage of additional information relating to a member's health and lifestyle. Stored in the various columns, information such as a binary indicator to specify the member is a smoker, or an integer representation of a body mass value representation of a member's weight can be stored along with genetic data. In this way, when a study relates to genetic discovery in conjunction with other health factors, the database is populated with digital representations of these. Among the data which is useful to associate with a single member include: lifestyle factors; metabolic measurements; family history; medical record data; exercise regimen, among others.

While each of these categories of information are interesting in their own right, a most important data element for these systems additionally includes a special contact specification. As a fundamental goal of these devices is to provide electronic alerts, it is necessary to specify where such alerts are to be directed. In most preferred versions and the alert is distributed by an electronic communications system fashioned as an “e-mail server”. For this reason, an important association made between any particular genome, other health information, and an alert delivering address such as an e-mail address or e-mail addresses, or physicians e-mail, or parent's e-mail addresses. Accordingly, these database are provided with schema to accommodate health data in conjunction with at least one e-mail address designated for alerts.

In view of the rules formed by the rules generator module, a rule set is maintained as part of an analyzer module 210. A plurality of rules 211 stored form basis upon which a query engine 212 might probe the database so prepared with genetic information associated with its membership. In example, a new study may suggest a person is at greater risk of developing some disease when they are found to have a known polymorphism 213 (SNP1) in their genetic sequence. Inquiry may be run against the database of member information to produce a result set 214 of all members having the polymorphism. Queries may be run whenever a new rule arrives in the rules set, or may be timed 215 to run periodically. When a query produces a result set and one or more member meets the criteria set forth in the rule, those member records are sent to the alert module. For each member, a customized report may be prepared which reflects details of the new study. The precise implications might be different for any two groups of people i.e. a newly discovered cancer gene may be more significant for smokers than for nonsmokers in agreement with the study. In another illustrative example, a certain report may be more appropriate for members of advanced age and that two may be accounted for in the templates 217 stored as part of the alert module.

Once finally prepared, the alerts are transmitted and distributed electronically for example via an SMTP e-mail server coupled to the Internet 218 to a user/member workstation 219 where those alerts and alert reports may be viewed on a standard HTML browser 210 or custom desktop application 221.

In accordance with each of preferred embodiments of these inventions, genetics based alerting systems are provided. It will be appreciated that each of the embodiments described include an apparatus and that the apparatus of one preferred embodiment may be different than the apparatus of another embodiment. Accordingly, limitations read in one example should not be carried forward and implicitly assumed to be part of an alternative example.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

One will now fully appreciate how one may realize a genetics based alerting system which monitors new research to provide alerts relevant to particular members of the system membership. Although the present inventions have been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

What is claimed is:

1) A genomics-based computer alerting system comprising:
a membership database of recorded member genome data;
an analyzer module including a plurality of algorithms stored as a rule set and a query engine coupled to said membership database whereby queries formed in the query engine may be run against data stored in the membership database, the analyzer module further having a result set output coupled to an alert module;
a rules generator including an expert interface and data processor coupled to a research community whereby the rules generator operates to convert qualitative research studies into quantitative and discrete rules and convey those rules to the analyzer module,
the alert module comprising template reports whereby reports are generated and configured in agreement with information received in said result set.
